(19) United States
(12) Patent Application Publication
(10) Pub. No.: US 2013/0298071 A1
(43) Pub. Date: Nov. 7, 2013

(54) FINGER TEXT-ENTRY OVERLAY

(71) Applicant: Jonathan Wine, Lakeside, CA (US)

(72) Inventor: Jonathan Wine, Lakeside, CA (US)

(21) Appl. No.: 13/462,015

(22) Filed: May 2, 2012

(51) Int. Cl. G06F 3/048

(52) U.S. Cl. 715/780

(57) ABSTRACT

Systems and methods for providing text entry on a limited-display device, such as a mobile device or in-vehicle device. In an embodiment, a partially transparent virtual overlay is generated and rendered on a display of the device on top of a user interface. Finger-written characters or character strings are received through the virtual overlay via a touch-screen of the device. The recognized characters or character strings are displayed in an input field of the user interface, such that the characters or character strings are visible through the partially transparent virtual overlay.

### FIELD OF THE INVENTION

The systems and methods disclosed herein relate generally to data entry, and particularly, to a virtual overlay for a mobile or other limited-display device which enables text entry using one or more fingers of a user of the device.

### BACKGROUND

Conventional touch-screen enabled devices, such as smart phones (e.g., iPhone®) or tablet devices (e.g., iPad®), offer a mode in which the user can use his or her finger to enter text into the device. Generally, a virtual or “soft” keyboard (e.g., a QWERTY display) will slide up to cover a portion of the device's display area. Typically, the display area comprises an integrated touch-screen that is capable of detecting physical interactions with objects displayed in the display area. For instance, the user of such a device may tap the “keys” of the virtual keyboard to enter characters (e.g., letters, numbers, punctuation marks, special characters, etc.) into a text box, which is generally displayed at the top of the display area and above the virtual keyboard.

The majority of touch-screen enabled devices comprise limited display areas. This is generally due to the nature of the devices. For instance, in order to be marketable, a mobile phone must be small enough to fit into a standard-sized pocket. In addition, touch-screen-enabled devices in vehicles generally must be small enough to fit within a housing in the center console of the vehicle. Accordingly, the screens, and concomitantly the display areas, of such devices are frequently as small or smaller than the mobile device or housing.

Thus, as a result of the limited display areas common to most mobile or vehicle-installed devices, conventional virtual keyboards displace the context in which a text box or other virtual input exists. In other words, the virtual keyboard and a text box associated with the virtual keyboard are displayed in the display area, whereas the actual text box and the context (or a portion of the context) in which the actual text box exists are not displayed. Thus, a user of such a virtual keyboard often can neither see the actual text box nor its context as he or she is entering text using the virtual keyboard.

For example, a user of a conventional system may retrieve a user interface or other context, as shown in FIG. 1A. The user interface may be a webpage or the graphical user interface of an application comprising a plurality of elements, defined and laid out, for example, using Hypertext Markup Language (HTML). The elements may comprise one or more virtual inputs, including one or more text boxes or text areas. The elements may comprise other virtual inputs, such as drop-down menus, radio buttons, checkboxes, interactive buttons (e.g., for file browsing and selection, form submission, form reset, etc.), and the like. The elements may also comprise text, images, videos, animations, Flash content, advertisements, and other media, content, and the like.

When a user attempts to enter data into a text box, for example, by tapping the text box with his or her finger, a virtual keyboard and associated text box is displayed, as shown in FIG. 1B. It should be noted that the text box may not be the actual text box element displayed in the user interface of FIG. 1A, but may instead be a text box that is associated with and provided by the virtual keyboard. Such a text box generally does not have the same style and attributes as the text box of the user interface. Rather, the text box associated with the virtual keyboard may be rendered according to parameters defined by the provider of the virtual keyboard, not the provider of the user interface.

In FIG. 1B, it is shown that the virtual keyboard and associated text box take up the entire display area, or at least a significant portion of the display area. In doing so, the user interface, or at least a significant portion of the user interface is displaced or hidden by the virtual keyboard. The displaced portion of the user interface may even include the text box for which text is being entered. Accordingly, at least a portion, if not all, of the context for the text box (i.e., the other elements of the user interface) is not visible to the user while the user is entering text for the text box.

In many cases, the loss of such context is undesirable. For instance, the text that should be entered for the text box may be dependent on other elements of the user interface. If those elements are not visible to the user, the user may have trouble entering the appropriate character string into the text box. The user may be forced to open (i.e., display) and close (i.e., hide) the virtual keyboard multiple times in order to enter the desired or necessary information. One simple example is the case of anti-bot mechanisms (e.g., reCAPTCHA). Such mechanisms force a user to enter characters, which are often distorted, from an image into a text box before gaining access to a resource. If the image is displaced by the virtual keyboard, it may be difficult for the user to remember the image long enough to interpret and enter the distorted characters in one continuous interaction. Another simple example, in which it would be desirable to view the context of an input field while entering text, is when there are descriptions (e.g., what to enter into the input field, the format in which to enter the data, etc.), instructions (e.g., how to enter the data, a checklist of what to enter, etc.), specific restrictions (e.g., requirements for the field, acceptable characters for a password or other field, etc.), or the like associated with the input field. In this case, it would be desirable to view this description or other information while entering the data into the input field. As a further example, the user interface may comprise media, such as a video or animation, which the user may wish to continue viewing while entering data into various input fields of the user interface. It will be easily understood that there are numerous other contexts in which it would be desirable to view the context in which text or other data is being entered.

### SUMMARY

Accordingly, an objective of the disclosed systems and methods is to solve these shortcomings of current virtual keyboard technology by providing a virtual overlay which preserves the context of an input field, such that a user may enter data, such as text, into the input field while simultaneously viewing the input field and its context. In this manner, a user of a limited-display device can enjoy a friendlier and more visually appealing data-entry experience with respect to his or her device.

Accordingly, a method for providing data entry on a mobile device is disclosed. In an embodiment, the method comprises: in response to a selection of an input field of a user interface, generating a partially transparent virtual overlay on a display area of the mobile device, such that at least a portion of the user interface is visible through the virtual overlay; receiving a drawing on the virtual overlay, wherein the drawing is indicative of at least one character; converting the drawing into the at least one character; and causing the at least one character to be displayed in the input field, such that the at least one character is visible through the virtual overlay.

In addition, a non-transitory computer-readable medium, having stored thereon one or more instructions, is disclosed. The one or more instructions cause one or more hardware processors to in response to a selection of an input field of a user interface, generate a partially transparent virtual overlay on a display area of the mobile device, such that at least a portion of the user interface is visible through the virtual overlay; receive a drawing on the virtual overlay, wherein the drawing is indicative of at least one character; convert the drawing into the at least one character; and cause the at least one character to be displayed in the input field, such that the at least one character is visible through the virtual overlay.

Furthermore, a system for providing data entry on a mobile device is disclosed. In an embodiment, the system comprises at least one executable module that, when executed by the at least one hardware processor, in response to a selection of an input field of a user interface, generates a partially transparent virtual overlay on a display area of the mobile device, such that at least a portion of the user interface is visible through the virtual overlay, receives a drawing on the virtual overlay, wherein the drawing is indicative of at least one character, converts the drawing into the at least one character, and causes the at least one character to be displayed in the input field, such that the at least one character is visible through the virtual overlay.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1A illustrates an example of a user interface;

FIG. 1B illustrates an example of a conventional virtual keyboard, according to the prior art;

FIG. 2A illustrates an example of a user interface;

FIG. 2B illustrates an example of a virtual overlay, according to an embodiment;

FIGS. 3A-3D demonstrate entry of text using a virtual overlay, according to an embodiment;

FIG. 4 illustrates an example of a virtual overlay, according to an embodiment; and

FIG. 5 illustrates an example computer system that may be used in connection with various embodiments described herein.

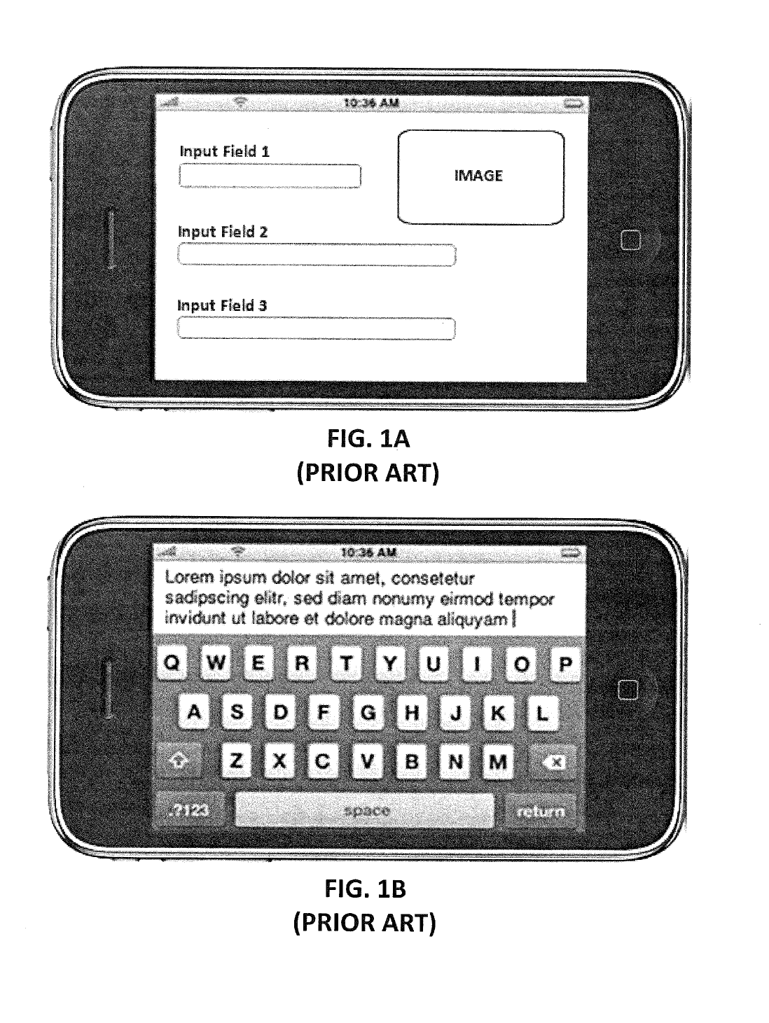

### DETAILED DESCRIPTION

According to an embodiment, an overlay module is provided on or for a device. The device may be a limited-display device, for example, having a display screen with a diagonal of 10 inches or less. These devices can include, without limitation, mobile phones (e.g., smart phones), tablet computers, personal digital assistants, hand-held navigation systems, vehicle interfaces (e.g., build-in navigation systems, media and environmental controls, etc.), and the like. While the disclosed embodiments are not limited to such limited-display devices and may also be used in conjunction with desktops or other personal computers having touch-screen interfaces, it is believed that limited-display devices are most benefited by the disclosed embodiments.

The overlay module may be implemented in software capable of being executed by a processor. Alternatively, the overlay module may be implemented in hardware, or a combination of software and hardware. The overlay module may be a stand-alone application or may be a module of an operating system. In an embodiment, the overlay module utilizes an application programming interface (API) of an operating system platform. For instance, the Android platform (which comprises an operating system, middleware, and key applications), versions 1.5 and later, offers an Input Method Framework (IMF) that allows developers to create on-screen input methods, such as software keyboards. The platform provides a central API to the overall IMF architecture, referred to as the input method manager, which arbitrates interactions between applications on a device and input methods for the device.

The overlay module may utilize the input method manager to communicate with a global system service that manages interactions across all processes. In particular, the overlay module may implement a particular interaction model which allows the user of a mobile device to generate text or other data. The system will bind to the overlay module, causing it to be executed. In this manner, the overlay module can direct the system, for example, to display or hide an overlay, or various aspects of the overlay, generated by the overlay module.

The overlay module may generate a transparent input box or other virtual input element. The transparent input box may be generated as a transparent overlay over a third-party application or browser configured to receive data input and executing on the device. This transparent overlay may be generated in response to a user interaction. For example, the user interaction may comprise the user selecting or focusing on an input field (e.g., a textbox) of a user interface of the third-party application or a webpage using a touch-screen or other input mechanism of the device. Other examples of user interactions include, without limitation, selecting a virtual button or icon, pressing a physical button or key of the mobile device, moving or tabbing a cursor to the input field, and the like.

In an embodiment, the overlay module animates the display of the virtual overlay. The animation may be in response to a user interaction with the input field, as discussed above. As one example, the overlay module may display the virtual overlay increasing in size over a period of time. The virtual overlay may increase in size beginning from a starting point of the input field with which it is associated. In other words, the overlay module may animate the virtual overlay such that it appears that the input field is expanding in one or more directions until it reaches the final size of the virtual overlay. Preferably, the overlay is enlarged rapidly to its final size. When fully enlarged, the virtual overlay may fill the entire display area of the device or a portion or percentage (e.g., 95%) of the display area. If the virtual overlay fills only a percentage of the display area, it may be vertically centered and/or horizontally centered within the display area.

In an embodiment, the overlay module renders the virtual overlay as partially transparent. The overlay module may render the virtual overlay according to a predetermined level or percentage of transparency (e.g., 75% transparent). This level of transparency may be a non-configurable system or application setting. Alternatively, the level of transparency may be a configurable setting which is capable of being initially set and/or subsequently modified by the user, and may initially be set at a default level. Advantageously, the transparency of the virtual overlay allows a user to view the context (e.g., user interface of a webpage or application) of the input field through the virtual overlay while he or she is entering data into the input field. The context does not have to change or be displaced to enable text or other data entry. Rather, the context, as it existed prior to selection of an input field, can be displayed unchanged through or beneath the virtual overlay. In this manner, context-dependent data entry is facilitated. Alternatively, it should be understood that the same effects can be achieved, without departing from the spirit of the disclosed embodiments, if instead the virtual overlay is rendered as opaque, and the context is rendered as a transparent layer over the virtual overlay (although this may unnecessarily complicate interactions with the virtual overlay using the touch-screen interface).

A user of a device implementing the disclosed virtual overlay may enter characters, strings, or other input into the input field using the virtual overlay. For instance, the user may use his or her finger or fingers to spell out each letter or word on the virtual overlay, as if he or she is writing the letter or word using his or her finger. For instance, the user may swipe his or her finger across the virtual overlay (i.e., maintain continuous contact with the touch-screen), and the overlay module or another module interfaced with the overlay module, such as a handwriting recognition module, may automatically recognize or predict the character or character string (e.g., word) that the user has input or attempted to input. If the module is unable to match or predict the character or string with sufficient certainty, the module may prompt the user to choose from a list of potentially matching characters or strings or reenter the character or string. In an embodiment, the user may use a stylus instead of his or her finger or any other object capable of being sensed by the touch-screen interface of the device.

In an embodiment, the user of the device may spell out character or strings in a natural, intuitive manner with his or her finger, as if the user is writing the character or string with pen and paper. Handwriting recognition technology is used to identify what the user has entered. For example, MyScript® by Vision Objects® can be utilized to recognize characters or strings input into the virtual overlay generated by the overlay module. Alternatively or additionally, the overlay module or a separate handwriting recognition module may recognize a set of shorthand characters and commands. For example, Palm® Graffiti® is an essentially single-stroke shorthand handwriting recognition system that is based primarily on a constructed script (neography) of uppercase characters that can be drawn blindly with a stylus or touch-screen sensor.

It should be understood that any of a variety of handwriting recognition technologies may be used without departing from the spirit of the disclosed embodiments. Furthermore, the overlay module may provide a user of a mobile device with the option of choosing among a number of different handwriting technologies to be used with the transparent overlay. For instance, the overlay module may be capable of interfacing with a plurality of handwriting recognition modules which each implement a different handwriting recognition technology. The overlay module may further store or access a system setting or user setting that specifies which of the handwriting recognition modules should be used in conjunction with the transparent overlay. The setting may be initially set to use a default handwriting recognition module.

In an embodiment, as the user of the device enters the characters or strings into the transparent overlay using his or her finger, the overlay module represents the path of the user's finger in order to facilitate the user's input of text. For instance, as the user swipes his or her finger on the transparent overlay, the overlay module may shade or color the pixels on the display area corresponding to each area of a touch-screen sensor that is touched by the user. The path of the user's finger may be shaded or colored in an opaque or semi-transparent manner. In an embodiment, the transparency of the path may be the same or different from the transparency of the overlay. After a character or string is entered and/or recognized by the handwriting recognition module, it may be erased from the transparent overlay in anticipation of the next character or string input. Alternatively, the overlay module may not represent the path of the user's finger. While this feature is advantageous when entering strings of multiple characters, it may not be as beneficial for entering single characters.

In an embodiment, as each character or string is entered by the user through the transparent virtual overlay, it is entered into the input field, for example, using the input method manager of the platform. Since the virtual overlay is transparent, each selected character may be displayed (e.g., appended to the previously selected characters, or the new string substituted for the previously displayed string), at the time it is entered, within the actual input field as it exists within its context (e.g., the user interface of a webpage or application). The user can clearly see the context in which he or she is entering the text or other data through the transparent virtual overlay. In this manner, the input field, which may be a textbox, never needs to change location or be displaced or hidden in order to enable entry of text or other data.

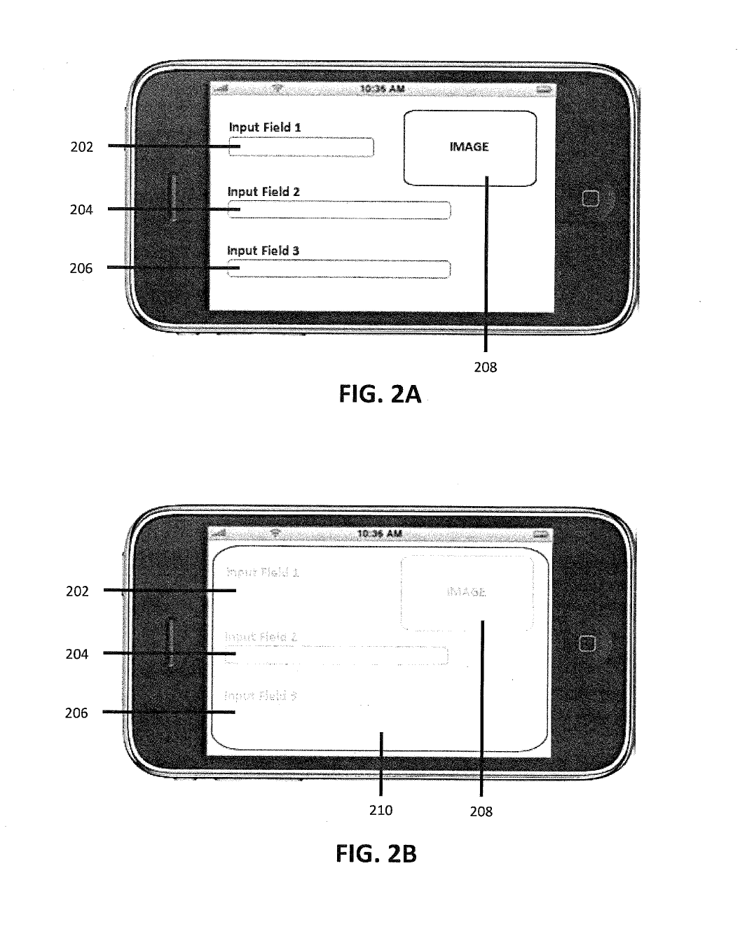

With reference to FIGS. 2A and 2B, an example of a text-entry overlay is demonstrated, according to an embodiment. Initially, a user of the mobile device may be viewing a user interface, illustrated in FIG. 2A, such as an application interface or a webpage in a browser (e.g., rendered using Hypertext Markup Language (HTML)). The user interface may comprise one or more input fields (e.g., 202, 204, and 206), and one or more images (e.g., 208). It should be understood that the user interface may comprise numerous other or different types of elements, including, without limitation, text, videos, media, animations, hyperlinks, and the like.

The user selects an input field, such as input field 204, by touching the location of input field 204 on the display area. In an embodiment, the input field 204 may be highlighted or otherwise distinguished from other unselected input fields (e.g., 202 and 206). In response to the user interaction of selecting the input field 204, the overlay module is executed. The overlay module generates transparent virtual overlay 210, which is displayed on the entire display area or the majority of the display area, as illustrated in FIG. 2B. Notably, the user interface, including input fields 202, 204, and 206 and image 208 remain visible through the virtual overlay 210. Thus, the user may continue viewing the context of the input field 204 as he or she enters text into the input field 204 via the virtual overlay 210.

Once a user is finished entering text into the transparent virtual overlay for a particular input field, he or she may interact with the virtual overlay or with the mobile device directly to close or hide the transparent overlay. For example, the overlay module or handwriting recognition module may be capable of recognizing a termination interaction, such as a double-tap on the virtual overlay or other interaction with the virtual overlay. Alternatively or additionally, the virtual overlay may comprise a button or icon (e.g., in a corner of the transparent overlay), or the mobile device may comprise a physical button (e.g., a return or back button), which the user may press in order to indicate that he or she is done entering text. In response to the terminating interaction, the overlay module or platform may close or hide the virtual overlay, thus returning focus to the user interface, as illustrated in FIG. 2A.

Additionally, in an embodiment, the virtual overlay may comprise a button or icon, or the mobile device may comprise a physical button, which the user may press in order to tab to the next input field of the user interface. In response, the next input field may be highlighted or otherwise distinguished from the other input fields of the user interface. Thereafter, characters or strings entered into the virtual overlay are fed to the next input field.

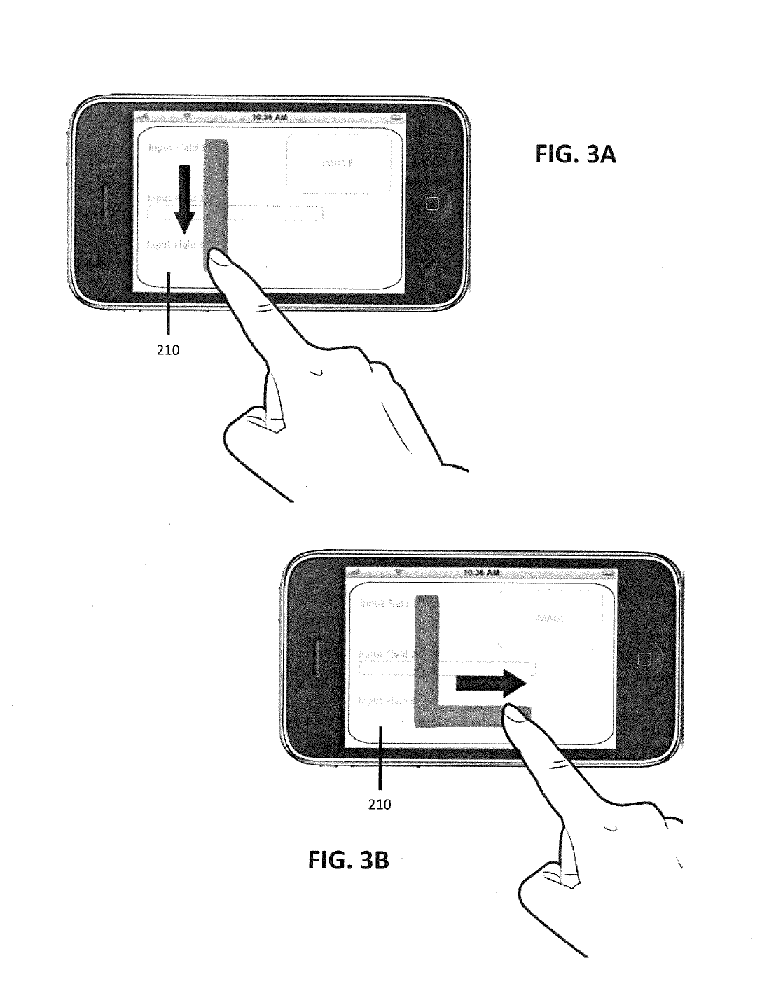

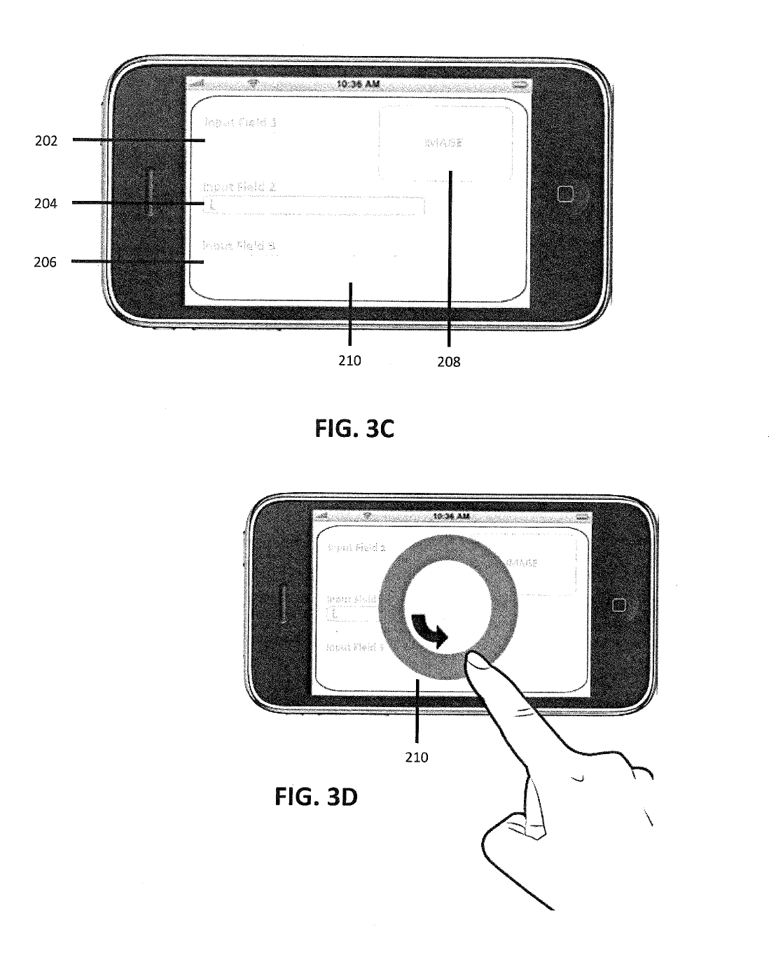

FIGS. 3A-3D demonstrate how a user of a device may utilize the transparent virtual overlay 210 to enter text into an input field 204 of the user interface. Specifically, the user may use his or her finger to sketch a letter or word on the virtual overlay 210.

FIGS. 3A and 3B illustrate a finger drawing the letter “L” on the virtual overlay 210. First, the user swipes his or her finger down from the top to the bottom of the virtual overlay, as shown in FIG. 3A. Second the user swipes his or her finger from left to right across virtual overlay 210, as shown in FIG. 3B. This action of drawing the letter “L” may be performed in one continuous motion (i.e., with the user's finger or stylus maintaining contact with the display screen of the device during the entire interaction). While a mobile device is shown, it should be understood that the disclosed embodiments are not limited to mobile devices, and may be used with other types of devices. Furthermore, while the device is shown being used in a sideways fashion, it should be appreciated that the device may be used in the same manner in an upright fashion.

Once the user has finished drawing the letter “L” on the transparent overlay, the user may lift his or her finger, or otherwise indicate that he or she has completed entry of the letter. When the overlay module receives the indication that the user has entered a letter or other character, or while the overlay module is receiving the character, the overlay module may attempt to recognize the character that was input. In an embodiment, the overlay module may pass the image or other digital object representing the entered character (e.g., a graph-based data structure representing the entered character) to a handwriting recognition module.

The overlay module or handwriting recognition module may process the input to determine what character it represents. In the illustrated example, the module would determine that the user has entered an “L”. Accordingly, the letter “L” will be entered into input field 204. In an embodiment, the value “L” is passed from the overlay module or handwriting recognition module to the input field 204 of the user interface, for example, through an API provided by the platform of the device. Notably, the value of the input field 204, which comprises “L”, is visible through the transparent overlay 210, along with its context, which includes the input fields 202, 206, and image 208. This is illustrated in FIG. 3C. Accordingly, if the user subsequently enters another character into the transparent overlay 210, he or she will be able to see what characters have previously been entered into the input field 204. For example, as illustrated in FIG. 3D, as the user enters a second character (i.e., “O” in this example) into the transparent virtual overlay 210, the input field 204, including the previously entered character “L” is visible through the virtual overlay 210.

In an alternative embodiment, the overlay module may be configured to receive multiple characters at one time. In other words, instead of the user entering one character at a time into the transparent virtual overlay 210, the user may enter multiple characters, such as an entire word or sentence, into the virtual overlay 210. The handwriting recognition module may be configured to recognize entire words or sentences, and translate the recognized words or sentences into text, which may then be input into an input field (e.g., 204).

In the event that the overlay module or handwriting recognition module is unable to recognize the character or string input by the user into the transparent virtual overlay 210, the overlay module may produce an error message or other indication which notifies the user that the character or string could not be recognized.

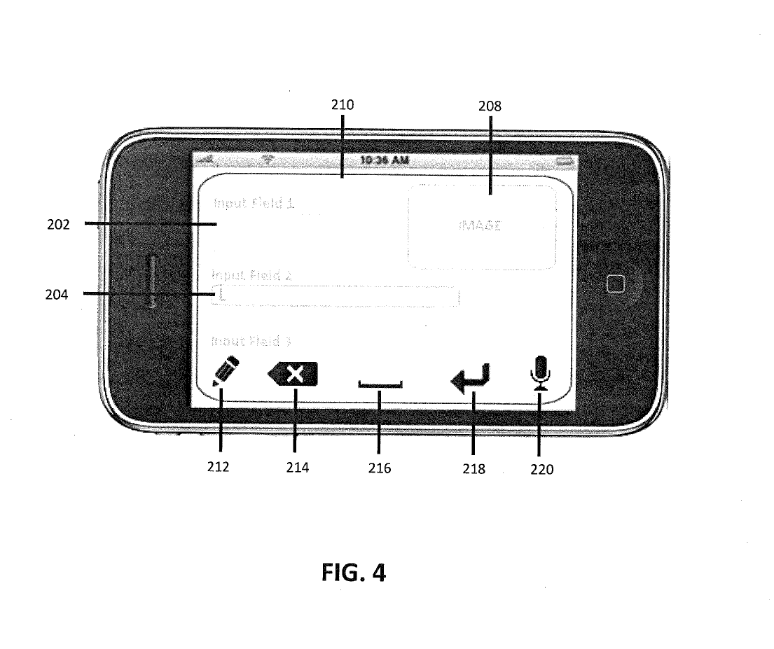

FIG. 4 illustrates a virtual overlay, according to an additional embodiment. In this embodiment the virtual overlay 210 comprises one or more icons, such as icons 212, 214, 216, 218, and 220. While the icons are depicted along the bottom of the overlay 210, it should be understood that the icons can be configured in alternative arrangements. For instance, in an embodiment, the icons (e.g., 212-220) are displayed along the bottom of the overlay 210 when the device is in portrait mode (i.e., when the top and the bottom edges of the user interface are parallel to the shorter sides of the device), and the icons (e.g., 212-220) are displayed along a right or left side of the overlay 210 when the device is in landscape mode (i.e., when the top and the bottom edges of the user interface are parallel to the longer sides of the device). This configuration ensures that the drawing area of the overlay remains substantially a square.

In an embodiment, the icons of the overlay module may comprise optional and/or non-optional icons. The optional icons may be added or removed by a user of the device, either individually or as a group. The user may also be permitted to set and modify the configuration or arrangement of the icons. These user settings (i.e., which icons to display and the configuration or arrangement of the icons) may be stored in a non-volatile memory of the device by the overlay module.

FIG. 4 illustrates five icons 212, 214, 216, 218, and 220. An icon may be activated by a click or a tap on an area of a touch-screen of the device that corresponds to the icon. Icon 212 represents an edit button that, when activated, opens a standard virtual or “soft” keyboard. Easy access to the soft keyboard may be convenient for a user to proofread and enter corrections to inputted text. In an embodiment, icon 212 can be linked to any alternative input method (e.g., a non-standard soft keyboard or keypad) by the user. This link can comprise a user setting, which is set by the user and stored in a non-volatile memory of the device by the overlay module.

Icon 220 represents a speech-to-text input that, when activated, executes a speech-to-text entry application. This can be any standard or non-standard application which receives spoken words via a microphone of the device and converts them into text. Again, the application to which icon 220 links can be a user setting, which is set by the user and stored in a non-volatile memory of the device by the overlay module. It should be understood that default settings can be provided for any of the user settings. In an embodiment, icons 212 and 220 can be non-optional icons, which are always displayed in corners of the virtual overlay in order to keep them out of the way.

Icons 214, 216, and 218 in FIG. 4 represent the whitespace characters, backspace, space, and carriage return, respectively. It should be appreciated that the icons could comprise additional or alternative whitespace characters, such as a tab. Also, in an embodiment, an icon can be provided that, when activated, indicates to the overlay module that the user is finished entering text. This icon can be provided in addition to or as an alternative to the illustrated icons (e.g., as an alternative to carriage return icon 218). The whitespace characters can be provided as an alternative to providing a neography for the characters, or in addition to providing a neography (e.g., in the handwriting recognition module) for the characters in order to fill in gaps in a user's knowledge of the neography. Once the user learns the neography, which may be a proprietary neography, in an embodiment, the user may turn off the whitespace characters via user settings of the overlay module.

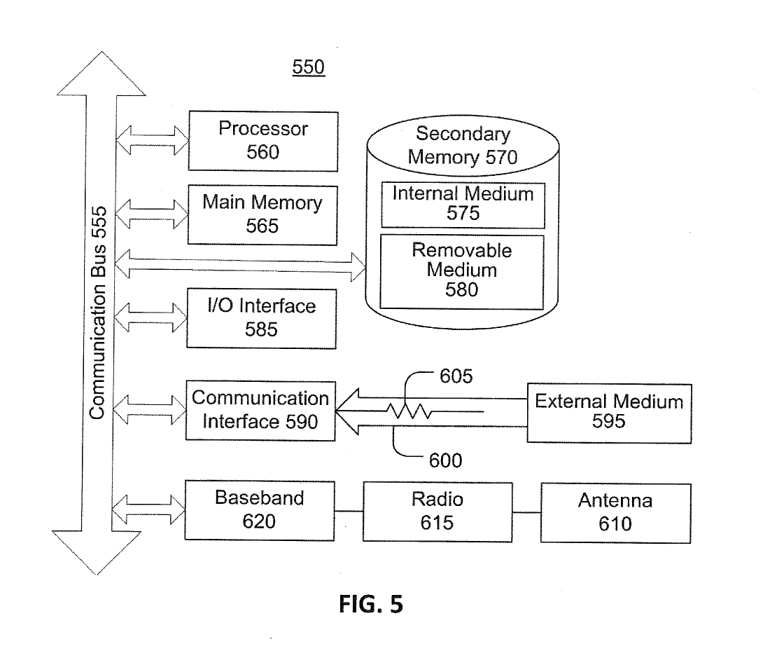

FIG. 5 is a block diagram illustrating an example wired or wireless system 550 that may be used in connection with various embodiments described herein. For example the system 550 may be used as or in conjunction with an overlay module and/or handwriting recognition module, as previously described with respect to FIGS. 2-3D. The system 550 can be a conventional personal computer, computer server, personal digital assistant, smart phone, tablet computer, vehicle navigation and/or control system, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560, such as the overlay module and/or handwriting recognition module discussed above. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include a internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown) that were previously described with respect to FIGS. 2 and 3.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent certain embodiments of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A method for providing data entry on a mobile device, the method comprising, by at least one hardware processor of a mobile device:
in response to a selection of an input field of a user interface, generating a partially transparent virtual overlay on a display area of the mobile device, such that at least a portion of the user interface is visible through the virtual overlay;
receiving a drawing on the virtual overlay, wherein the drawing is indicative of at least one character;
converting the drawing into the at least one character; and
causing the at least one character to be displayed in the input field, such that the at least one character is visible through the virtual overlay.

2. The method of claim 1, further comprising, after causing the at least one character to be displayed in the input field:
receiving a second drawing on the virtual overlay, wherein the second drawing is indicative of a second at least one character;
converting the second drawing into the second at least one character; and
causing the second at least one character to be displayed in the input field.

3. The method of claim 1, wherein converting the drawing into the at least one character comprises:
sending the drawing to a handwriting recognition module; and,
in response to sending the drawing, receiving the at least one character.

4. The method of claim 1, wherein receiving a drawing on the virtual overlay comprises receiving an interaction of a user with a touch-screen of the mobile device.

5. The method of claim 1, comprising rendering the virtual overlay at one or more of:
a predetermined percentage of the display area; and
a predetermined value of transparency.

6. The method of claim 1, wherein the virtual overlay comprises one or more selectable icons.

7. The method of claim 6, wherein the one or more selectable icons comprise one or more of:
a first icon which, when selected, initiates a display of a virtual keyboard on the display area; and
a second icon which, when selected, initiates a speech-to-text application.

8. The method of claim 7, wherein the one or more selectable icons comprise both the first icon and the second icon, and the first icon and the second icon are displayed in separate corners of the virtual overlay.

9. The method of claim 6, wherein the one or more selectable icons comprise selectable representations of whitespace characters, wherein each of the selectable representations, when selected, causes a whitespace character to be applied to the input field.

10. A non-transitory computer-readable medium, having stored thereon one or more instructions for causing one or more hardware processors to:
in response to a selection of an input field of a user interface, generate a partially transparent virtual overlay on a display area of the mobile device, such that at least a portion of the user interface is visible through the virtual overlay;
receive a drawing on the virtual overlay, wherein the drawing is indicative of at least one character;
convert the drawing into the at least one character; and
cause the at least one character to be displayed in the input field, such that the at least one character is visible through the virtual overlay.

11. The non-transitory computer-readable medium of claim 10, wherein the one or more instructions cause the one or more hardware processors to, after causing the at least one character to be displayed in the input field:
receive a second drawing on the virtual overlay, wherein the second drawing is indicative of a second at least one character;
convert the second drawing into the second at least one character; and
cause the second at least one character to be displayed in the input field.

12. The non-transitory computer-readable medium of claim 10, wherein converting the drawing into the at least one character comprises:
sending the drawing to a handwriting recognition module; and,
in response to sending the drawing, receiving the at least one character.

13. The non-transitory computer-readable medium of claim 10, wherein receiving a drawing on the virtual overlay comprises receiving an interaction of a user with a touch-screen of the mobile device.

14. The non-transitory computer-readable medium of claim 10, wherein the one or more instructions cause the one or more hardware processors to render the virtual overlay at one or more of:
a predetermined percentage of the display area; and
a predetermined value of transparency.

15. The non-transitory computer-readable medium of claim 10, wherein the virtual overlay comprises one or more selectable icons.

16. The non-transitory computer-readable medium of claim 15, wherein the one or more selectable icons comprise one or more of:
a first icon which, when selected, initiates a display of a virtual keyboard on the display area; and
a second icon which, when selected, initiates a speech-to-text application.

17. The non-transitory computer-readable medium of claim 16, wherein the one or more selectable icons comprise both the first icon and the second icon, and the first icon and the second icon are displayed in separate corners of the virtual overlay.

18. The non-transitory computer-readable medium of claim 15, wherein the one or more selectable icons comprise selectable representations of whitespace characters, wherein each of the selectable representations, when selected, causes a whitespace character to be applied to the input field.

19. A system for providing data entry on a mobile device, the system comprising:
at least one hardware processor; and
at least one executable module that, when executed by the at least one hardware processor,
in response to a selection of an input field of a user interface, generates a partially transparent virtual overlay on a display area of the mobile device, such that at least a portion of the user interface is visible through the virtual overlay,
receives a drawing on the virtual overlay, wherein the drawing is indicative of at least one character,
converts the drawing into the at least one character, and
causes the at least one character to be displayed in the input field, such that the at least one character is visible through the virtual overlay.

20. The system of claim 19, wherein the at least one executable module, after causing the at least one character to be displayed in the input field:
receives a second drawing on the virtual overlay, wherein the second drawing is indicative of a second at least one character;
converts the second drawing into the second at least one character; and
causes the second at least one character to be displayed in the input field.
